(19) United States
(12) Patent Application Publication
(10) Pub. No.: US 2016/0210110 A1
(43) Pub. Date: Jul. 21, 2016

(54) AUDIO SYNCHRONIZATION BETWEEN VEHICLES AND MOBILE DEVICES

(71) Applicant: Ford Global Technologies, LLC, Dearborn, MI (US)

(72) Inventor: Casey Bryan FELDMAN, Sunnydale, CA (US)

(21) Appl. No.: 14/601,694

(22) Filed: Jan. 21, 2015

(51) Int. Cl. G06F 3/16

(52) U.S. Cl. CPC G06F 3/165

(57) ABSTRACT

A system including a vehicle computing platform and a mobile device may synchronize, over a connection between the vehicle computing platform and the paired mobile device, media content retrieved from a hardware source of media content of the vehicle. Responsive to a trigger event indicative of discontinued playback, the system may synchronize a playback position into the media content being played back by the vehicle, to allow the mobile device to continue the playback.

### TECHNICAL FIELD

Aspects of the disclosure generally relate to audio synchronization between vehicles and mobile devices.

### BACKGROUND

A user may place an audio disc into a head unit cd player of a vehicle, and play the audio through the vehicle audio system. The user may leave the vehicle, and later return to the vehicle. Upon return, the user may resume playback of the CD where it left off.

### SUMMARY

In a first illustrative embodiment, a vehicle system includes a vehicle computing platform configured to receive, over a connection to a paired mobile device providing a projected mobile device user interface to the vehicle computing platform, media content retrieved from a vehicle hardware source of media content; and responsive to a trigger event indicative of discontinued playback, synchronizing a playback position into the media content being played back by the vehicle to allow the mobile device to continue the playback.

In a second illustrative embodiment, a system includes a mobile device programmed to provide, over a connection to a vehicle, a projected user interface of a media application of the mobile device via a human-machine interface of the vehicle; and responsive to a trigger event indicative of discontinued vehicle playback of an instance of media content, synchronizing to the mobile device, over the connection, a playback position into the media content to allow the mobile device to continue the playback.

In a third illustrative embodiment, a computer-implemented method includes sending, to a mobile device over a connection between the mobile device and a vehicle paired to the mobile device, media content retrieved from a hardware source of media content of the vehicle; and responsive to trigger event indicative of discontinued playback, synchronizing a playback position into the media content being played back by the vehicle to allow the mobile device to continue the playback.

### BRIEF DESCRIPTION OF THE DRAWINGS

FIG. 1 illustrates an example diagram of a system that may be used to provide telematics services to a vehicle;

FIG. 2 illustrates an example of a portion of a vehicle performing media content synchronization between vehicles and mobile devices;

FIG. 3 illustrates an example projected user interface of the media synchronization application including an interface for the selection of media content;

FIG. 4 illustrates an example projected user interface of the media synchronization application including an import function;

FIG. 5 illustrates an example native user interface of the media synchronization application displayed by the mobile device; and

FIG. 6 illustrates an example process for the synchronization of media content between the computing platform and the mobile device.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Vehicle infotainment systems may include media hardware, such as tuners, optical disc players and internal hard drives, configured to provide stored media content to vehicle occupants. In an example, the vehicle infotainment system may include a feature whereby a user may save desired tracks or entire optical disks to the hard drive for later access. However, such media hardware may be unavailable for use by smartphones or other mobile devices connected to the vehicle infotainment system.

While a mobile device is connected to the vehicle infotainment system (e.g., via USB, WiFi, cloud services or some other protocol), a media synchronization application stored on the mobile device may be configured to project a user interface onto a display of the vehicle infotainment system to allow for selection and playback of media content. The media synchronization application may provide an option to (or may automatically) transfer or import music from the vehicle media hardware to the mobile device via the connection between the mobile device and the vehicle.

The media synchronization application may be further configured to synchronize media playback statue information with the vehicle infotainment system. For instance, if a song or other instance of media content is currently being played in the vehicle infotainment system, and the driver puts the vehicle in park or a key off is detected, then the media synchronization application may be configured to synchronize that current media content instance and playback position to the mobile device. To do so, in an example the media synchronization application may be configured to make use of model or manufacturer-specific extensions to the communications protocol utilized by the mobile device to interact with vehicle infotainment system hardware.

Thus, when the driver leaves the vehicle, as the media content and playback state may be transferred from the vehicle infotainment system to the mobile device, the driver may be able to use the media synchronization application of the mobile device to continue to experience the instance of media from where it left off. Further aspects of use of the media synchronization application are discussed in detail below.

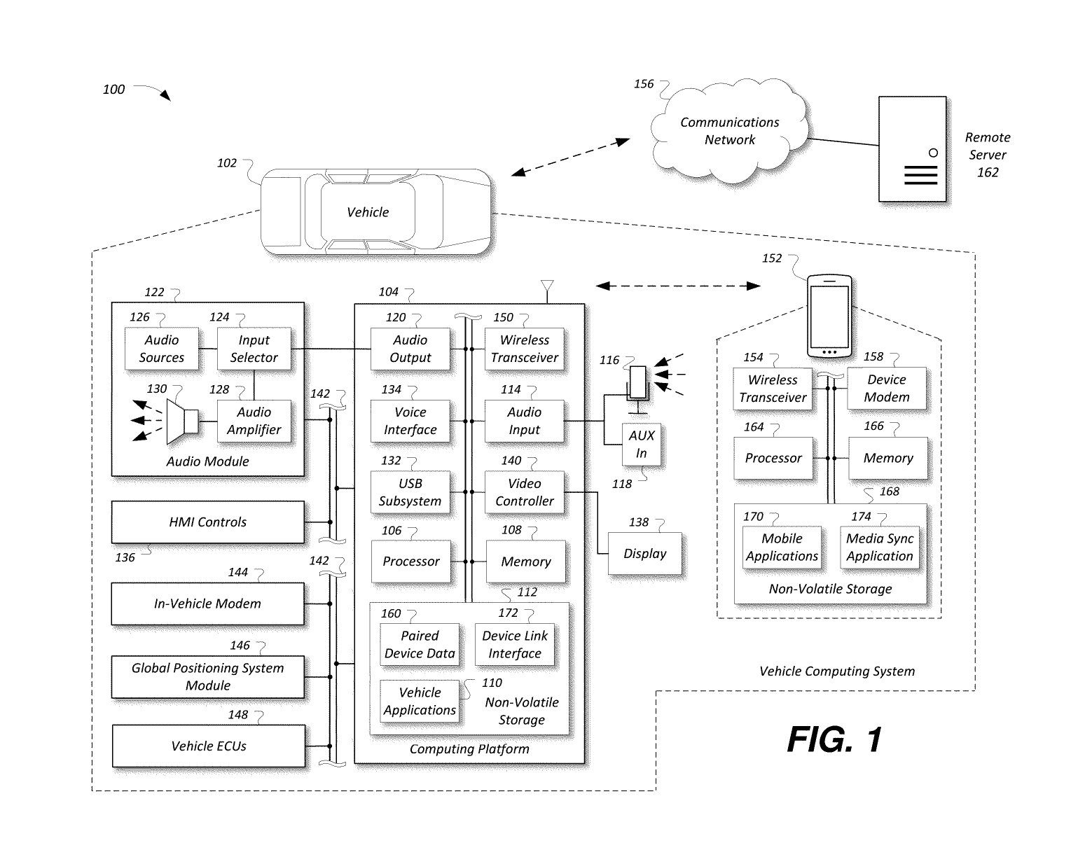

FIG. 1 illustrates an example diagram of a system 100 that may be used to provide telematics services to a vehicle 102. The vehicle 102 may be one of various types of passenger vehicles, such as a crossover utility vehicle (CUV), a sport utility vehicle (SUV), a truck, a recreational vehicle (RV), a boat, a plane or other mobile machine for transporting people or goods. Telematics services may include, as some non-limiting possibilities, navigation, turn-by-turn directions, vehicle health reports, local business search, accident reporting, and hands-free calling. In an example, the system 100 may include the SYNC system manufactured by The Ford Motor Company of Dearborn, Mich. It should be noted that the illustrated system 100 is merely an example, and more, fewer, and/or differently located elements may be used.

The computing platform 104 may include one or more processors 106 configured to perform instructions, commands and other routines in support of the processes described herein. For instance, the computing platform 104 may be configured to execute instructions of vehicle applications 110 to provide features such as navigation, accident reporting, satellite radio decoding, and hands-free calling. Such instructions and other data may be maintained in a non-volatile manner using a variety of types of computer-readable storage medium 112. The computer-readable medium 112 (also referred to as a processor-readable medium or storage) includes any non-transitory medium (e.g., a tangible medium) that participates in providing instructions or other data that may be read by the processor 106 of the computing platform 104. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

The computing platform 104 may be provided with various features allowing the vehicle occupants to interface with the computing platform 104. For example, the computing platform 104 may include an audio input 114 configured to receive spoken commands from vehicle occupants through a connected microphone 116, and auxiliary audio input 118 configured to receive audio signals from connected devices. The auxiliary audio input 118 may be a physical connection, such as an electrical wire or a fiber optic cable, or a wireless input, such as a BLUETOOTH audio connection. In some examples, the audio input 114 may be configured to provide audio processing capabilities, such as pre-amplification of low-level signals, and conversion of analog inputs into digital data for processing by the processor 106.

The computing platform 104 may also provide one or more audio outputs 120 to an input of an audio module 122 having audio playback functionality. In other examples, the computing platform 104 may provide the audio output to an occupant through use of one or more dedicated speakers (not illustrated). The audio module 122 may include an input selector 124 configured to provide audio content from a selected audio source 126 to an audio amplifier 128 for playback through vehicle speakers 130 or headphones (not illustrated). The audio sources 126 may include, as some examples, decoded amplitude modulated (AM) or frequency modulated (FM) radio signals, and audio signals from compact disc (CD) or digital versatile disk (DVD) audio playback. The audio sources 126 may also include audio received from the computing platform 104, such as audio content generated by the computing platform 104, audio content decoded from flash memory drives connected to a universal serial bus (USB) subsystem 132 of the computing platform 104, and audio content passed through the computing platform 104 from the auxiliary audio input 118.

The computing platform 104 may utilize a voice interface 134 to provide a hands-free interface to the computing platform 104. The voice interface 134 may support speech recognition from audio received via the microphone 116 according to grammar associated with available commands, and voice prompt generation for output via the audio module 122. In some cases, the system may be configured to temporarily mute or otherwise override the audio source specified by the input selector 124 when an audio prompt is ready for presentation by the computing platform 104 and another audio source 126 is selected for playback.

The computing platform 104 may also receive input from human-machine interface (HMI) controls 136 configured to provide for occupant interaction with the vehicle 102. For instance, the computing platform 104 may interface with one or more buttons or other HMI controls configured to invoke functions on the computing platform 104 (e.g., steering wheel audio buttons, a push-to-talk button, instrument panel controls, etc.). The computing platform 104 may also drive or otherwise communicate with one or more displays 138 configured to provide visual output to vehicle occupants by way of a video controller 140. In some cases, the display 138 may be a touch screen further configured to receive user touch input via the video controller 140, while in other cases the display 138 may be a display only, without touch input capabilities.

The computing platform 104 may be further configured to communicate with other components of the vehicle 102 via one or more in-vehicle networks 142. The in-vehicle networks 142 may include one or more of a vehicle controller area network (CAN), an Ethernet network, and a media oriented system transfer (MOST), as some examples. The in-vehicle networks 142 may allow the computing platform 104 to communicate with other vehicle 102 systems, such as a vehicle modem 144 (which may not be present in some configurations), a global positioning system (GPS) module 146 configured to provide current vehicle 102 location and heading information, and various vehicle ECUs 148 configured to cooperate with the computing platform 104. As some non-limiting possibilities, the vehicle ECUs 148 may include a powertrain control module configured to provide control of engine operating components (e.g., idle control components, fuel delivery components, emissions control components, etc.) and monitoring of engine operating components (e.g., status of engine diagnostic codes); a body control module configured to manage various power control functions such as exterior lighting, interior lighting, keyless entry, remote start, and point of access status verification (e.g., closure status of the hood, doors and/or trunk of the vehicle 102); a radio transceiver module configured to communicate with key fobs or other local vehicle 102 devices; and a climate control management module configured to provide control and monitoring of heating and cooling system components (e.g., compressor clutch and blower fan control, temperature sensor information, etc.).

As shown, the audio module 122 and the HMI controls 136 may communicate with the computing platform 104 over a first in-vehicle network 142-A, and the vehicle modem 144, GPS module 146, and vehicle ECUs 148 may communicate with the computing platform 104 over a second in-vehicle network 142-B. In other examples, the computing platform 104 may be connected to more or fewer in-vehicle networks 142. Additionally or alternately, one or more HMI controls 136 or other components may be connected to the computing platform 104 via different in-vehicle networks 142 than shown, or directly without connection to an in-vehicle network 142.

The computing platform 104 may also be configured to communicate with mobile devices 152 of the vehicle occupants. The mobile devices 152 may be any of various types of portable computing device, such as cellular phones, tablet computers, smart watches, laptop computers, portable music players, or other devices capable of communication with the computing platform 104. In many examples, the computing platform 104 may include a wireless transceiver 150 (e.g., a BLUETOOTH module, a ZIGBEE transceiver, a Wi-Fi transceiver, an IrDA transceiver, an RFID transceiver, etc.) configured to communicate with a compatible wireless transceiver 154 of the mobile device 152. Additionally or alternately, the computing platform 104 may communicate with the mobile device 152 over a wired connection, such as via a USB connection between the mobile device 152 and the USB subsystem 132.

The communications network 156 may provide communications services, such as packet-switched network services (e.g., Internet access, VoIP communication services), to devices connected to the communications network 156. An example of a communications network 156 may include a cellular telephone network. Mobile devices 152 may provide network connectivity to the communications network 156 via a device modem 158 of the mobile device 152. To facilitate the communications over the communications network 156, mobile devices 152 may be associated with unique device identifiers (e.g., mobile device numbers (MDNs), Internet protocol (IP) addresses, etc.) to identify the communications of the mobile devices 152 over the communications network 156. In some cases, occupants of the vehicle 102 or devices having permission to connect to the computing platform 104 may be identified by the computing platform 104 according to paired device data 160 maintained in the storage medium 112. The paired device data 160 may indicate, for example, the unique device identifiers of mobile devices 152 previously paired with the computing platform 104 of the vehicle 102, such that the computing platform 104 may automatically reconnected to the mobile devices 152 referenced in the paired device data 160 without user intervention.

When a mobile device 152 that supports network connectivity is paired with the computing platform 104, the mobile device 152 may allow the computing platform 104 to use the network connectivity of the device modem 158 to communicate over the communications network 156 with the remote telematics services 162. In one example, the computing platform 104 may utilize a data-over-voice plan or data plan of the mobile device 152 to communicate information between the computing platform 104 and the communications network 156. Additionally or alternately, the computing platform 104 may utilize the vehicle modem 144 to communicate information between the computing platform 104 and the communications network 156, without use of the communications facilities of the mobile device 152.

Similar to the computing platform 104, the mobile device 152 may include one or more processors 164 configured to execute instructions of mobile applications 170 loaded to a memory 166 of the mobile device 152 from storage medium 168 of the mobile device 152. In some examples, the mobile applications 170 may be configured to communicate with the computing platform 104 via the wireless transceiver 154 and with the remote telematics services 162 or other network services via the device modem 158. The computing platform 104 may also include a device link interface 172 to facilitate the integration of functionality of the mobile applications 170 into the grammar of commands available via the voice interface 134 as well as into display 138 of the computing platform 104. The device link interfaced 172 may also provide the mobile applications 170 with access to vehicle information available to the computing platform 104 via the in-vehicle networks 142. Some examples of device link interfaces 172 include the SYNC APPLINK component of the SYNC system provided by The Ford Motor Company of Dearborn, Mich., the CarPlay protocol provided by Apple Inc. of Cupertino, Calif., or the Android Auto protocol provided by Google, Inc. of Mountain View, Calif.

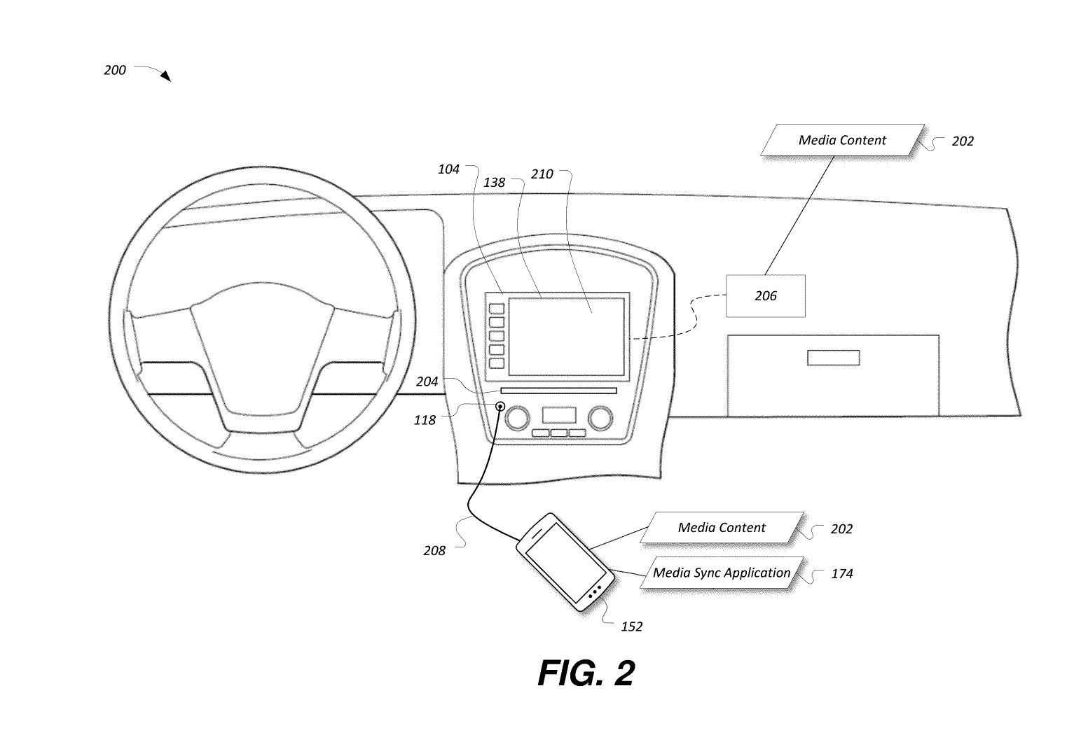

FIG. 2 illustrates an example 200 of a portion of a vehicle 102 performing synchronization of media content 202 between vehicles 102 and mobile devices 152. As illustrated, the vehicle 102 includes media hardware such as a media player device 204 configured to retrieve media content 202 from removable media and an internal media store 206 maintaining media content 202 on an vehicle storage device. The vehicle 102 also includes a mobile device 152 connected to the computing platform 104 via a connection 208 and configured to provide a projected user interface 210 of the media synchronization application 174 via the display 138 of the computing platform 104. It should be noted that the illustrated portion of the vehicle 102 is merely an example, and more, fewer, and/or differently located elements may be used.

Media content 202 may include, for example, one or more of audio media content 202 and video media content 202. Audio media content 202 may include music, such as songs or albums, as well as other types of audio, such as books on tape, recorded talk radio, audio commercials, or recorded phone calls, as some other possibilities. Video media content 202 may include content such as television, movies, and commercials, as some possibilities. The media content 202 may further include or otherwise be associated with media content 202 metadata, such as name, artist, title, track number, duration, rating, date recorded and date downloaded, as some non-limiting examples.

The media player device 204 may include various types of readers of removable media, such as a device configured to retrieve media content 202 from compact disks (CDs), digital versatile disks (DVDs), super audio CDs (SACDs), flash storage devices, or other types of recordable or read-only media storing media content 202. In many cases, the media player device 204 may be configured to provide the media content 202 retrieved from the media to the computing platform 104 to be provided to the audio module 122 for playback.

The internal media store 206 may include various types of storage devices for digital data, such as hard disk drives, solid state drives, and flash memories as some possibilities. The internal media store 206 may be configured to store and retrieve media content 202 provided to the internal media store 206 by a user of the vehicle 102. In an example, the vehicle computing platform 104 may provide a feature whereby the user may save media content 202 from a flash drive or other storage device connected to the computing platform 104 via the USB subsystem 132 or via another mechanism. In another example, the vehicle computing platform 104 may provide a feature whereby the user may load desired tracks or entire optical disks, captured using an optical disc player media player device 204, to the internal media store 206 for later access. Accordingly, the internal media store 206 may be configured to provide stored instances of the media content 202 to be provided to the audio module 122 for playback.

The connection 208 may include a USB connection between the mobile device 152 and the USB subsystem 132 of the computing platform 104. In an example, the connection 208 may serve as both a HMI channel between the computing platform 104 and a mechanism for charging the mobile device 152. As one possibility, the connection 208 may be provided according to a HMI communications protocol, such as the CarPlay protocol provided by Apple Inc. of Cupertino, Calif. In another possibility, the connection 208 may be provided according to the Android Auto protocol provided by Google, Inc. of Mountain View, Calif.

The projected user interface 210 may include a user interface generated by the mobile device 152, and transferred over the connection 208 to be shown on the display 138 of the computing platform 104. By way of the projected user interface 210, mobile applications 170 executed by the mobile device 152 may be able to utilize the HMI of the vehicle 102. In an example, the media synchronization application 174 may be configured to provide a projected user interface 210 via the display 138 of the computing platform 104.

In order to allow the mobile device 152 to utilize features of the computing platform 104 that are not exposed by the HMI communications protocol, the connection 208 may be further configured to provide commands beyond access to the HMI of the vehicle 102 from the mobile device 152 to the computing platform 104. These non-HMI commands may be provided as one or more of extensions to the HMI communications protocol, or extensions outside of the HMI communications protocol. These commands may include model-specific or manufacturer-specific commands programmed into the vehicle 102 for use by compatible applications. Thus, when the mobile device 152 is connected with a vehicle 102 lacking those extensions, or when the mobile device 152 is not connected to a vehicle 102, the functionality relying on the extensions may be unavailable from the mobile device 152.

In an example, the media synchronization application 174 may be configured to use these extensions to interact with the media hardware of the vehicle 102. Accordingly, mobile device 152 may utilize the extensions to allow media content 202 stored to the media player device 204 and the internal media store 206 to be made available for use by the media synchronization application 174.

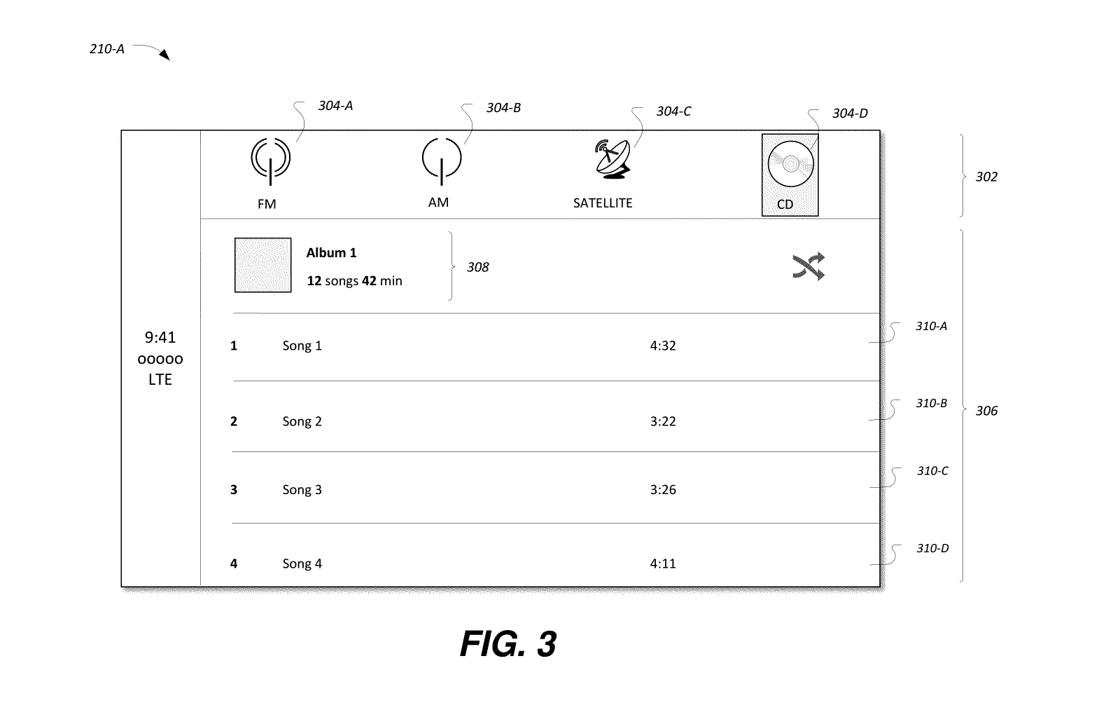

FIG. 3 illustrates an example projected user interface 210-A of the media synchronization application 174 including an interface for the selection of media content 202. The projected user interface 210-A may include a content sources listing 302 of one or more content sources 304, as well as a content item listing 306 of available instances of media content 202 within a corresponding selected content source 304 of the content sources listing 302.

The content sources listing 302 may include one or more sources of media content 202 that may be provided by the media hardware of the vehicle 102. As some examples, the content source listing 302 may include an FM radio content source 304-A (e.g., receiving content by way of a FM tuner of the vehicle 102), an AM radio content source 304-B (e.g., receiving content by way of an AM tuner of the vehicle 102), a satellite radio content source 304-C (e.g., receiving content by way of a satellite radio tuner of the vehicle 102), and a CD player content source 304-D (e.g., receiving content from the media player device 204). As shown, the CD player content source 304-D is currently selected, as indicated by the selection mark drawn surrounding the CD player content source 304-D indication.

The content item listing 306 may include one or more instances of media content 202 that may be provided by the selected content source. For example, for the currently selected CD player content source 304-D, the content item listing 306 may include album information 308 about the currently loaded media, as well as song information 310 for each of the songs of the media. As an example, the currently loaded CD may be titled “Album 1”, and may include 12 tracks totaling 42 minutes. Those tracks may include a first track 310-A titled “Song 1” with a running time of four minutes and thirty-two seconds, a second track 310-B titled “Song 2” with a running time of three minutes and twenty-two seconds, a third track 310-C titled “Song 3” with a running time of three minutes and twenty-six seconds, and a fourth track titled “Song 4” with a running time of four minutes and eleven seconds, for example.

In other examples, if the currently selected content source 304 is a broadcast source such as AM, FM or Satellite radio, the content item listing 306 may include a listing of available radio stations or streams, rather than a listing of instances of media content 202 included on the currently loaded media. In yet a further example, if the currently selected content source 304 is the internal media store 206 maintaining media content 202 (not shown in FIG. 3 as a content source 304), then the content item listing 306 may include a listing of the albums and songs stored to the internal media store 206.

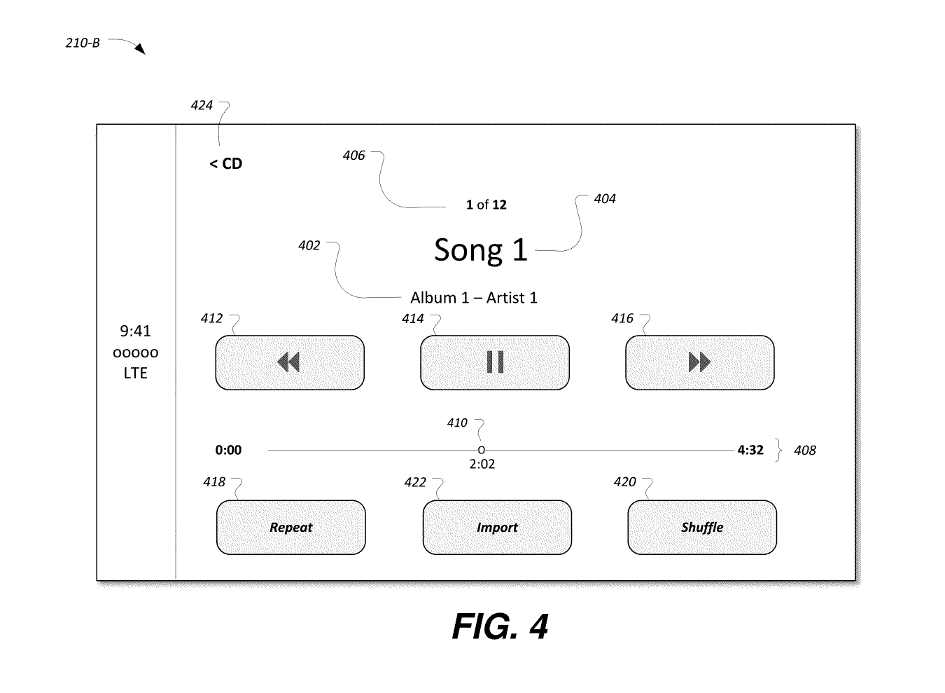

FIG. 4 illustrates an example projected user interface 210-B of the media synchronization application 174 including an import function. The projected user interface 210-B may include information and controls regarding an instance of media content 202 currently being played back via the computing platform 104.

For example, the user interface 210-B may include an album indication 402 of the currently played album and/or artist (e.g., “Album 1-Artist 1”), a song indication 404 of the currently played instance of media content 202 (e.g., “Song 1”), and a track indication of the currently played instance of media content 202 of the album (e.g., “track 1 of 12”). The user interface 210-B may also include a playback scale 408 indicating the length of the instance of media content being played back as well as a playback location 410 within the currently played instance of media content 202 (e.g., 2:02 through a track of length 4:32 as shown).

The user interface 210-B may further include various playback controls to allow a user to control the playback of the instance of media content 202. For example, the playback controls may include a rewind control 412 that, when selected by the user, is configured to move the playback location 410 to earlier within the instance of media content 202, a play/pause control 414 that, when selected by the user, is configured to toggle between playback and pausing of the instance of media content 202, and a fast-forward control 416 that, when selected by the user, is configured to move the playback location 410 to later within the instance of media content 202.

The user interface 210-B may also include a repeat control 418 that, when selected by the user, is configured to cause the playback to repeat the instance of media content 202 rather than proceeding to the next instance of media content 202 (e.g., the next track of the CD), and a shuffle control 420 that, when selected by the user, is configured to cause the playback to play the instances of media content 202 of the album in random order.

Moreover, the user interface 210-B may also include an import control 422 that, when selected by the user, is configured to cause the computing platform 104 to transfer the media content 202 being played by the computing platform 104 (or the entire album or other collection of media content 202 being played by the computing platform 104) to the user's connected mobile device 152. For example, responsive to selection of the import control 422, the mobile device 152 may be configured to request for the computing platform 104 to transfer the requested media content 202 to the mobile device 152 via the extensions to the connection 208. In another example, the mobile device 152 may automatically synchronize the media content 202 being played back, without user interaction. The mobile device 152 may accordingly receive the requested media content 202, and may store the media content 202 for playback by the mobile device 152. In an example, the media content 202 may be stored in a compartmentalized storage area utilized by the media synchronization application 174. In another example, the media content 202 may be imported into the media library of the mobile device 152. Accordingly, the media content 202 may be available for continued playback by the mobile device 152, even after the mobile device 152 has disconnected from the computing platform 104.

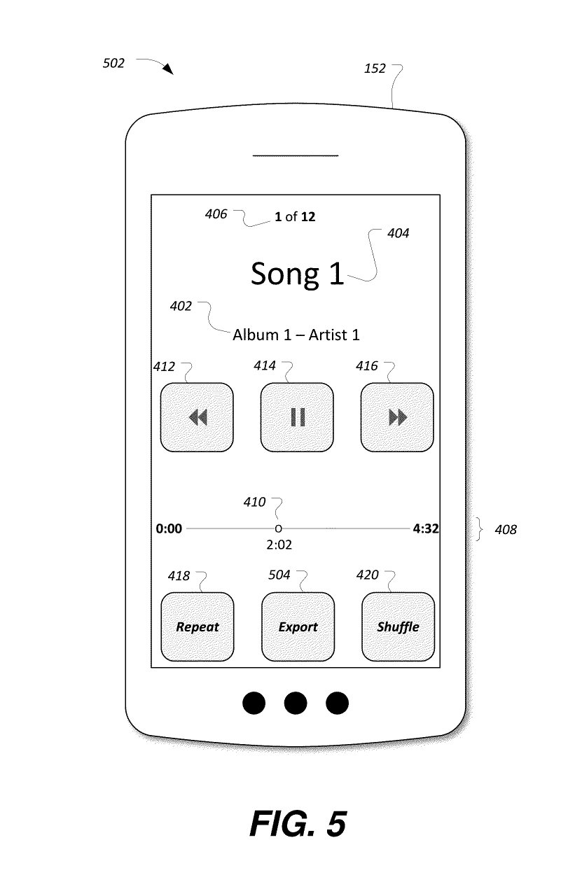

FIG. 5 illustrates an example native user interface 502 of the media synchronization application 174 displayed by the mobile device 152. The native user interface 502 may be displayed, for example, on a display of the mobile device 152 responsive to disconnection of the connection 208 between the mobile device 152 and computing platform 104. Once disconnected from the vehicle 102, the media synchronization application 174 may discontinue presentation of the projected user interface 210 utilizing the vehicle 102 HMI, and may instead provide the native user interface 502 utilizing the mobile device 152 HMI.

The native user interface 502 may include information and controls regarding the instance of media content 202 and playback position as synchronized with the computing platform 104 of the vehicle 102. For example, similar to the projected user interface 210-B, the native user interface 502 may include the album indication 402 of the currently played album and/or artist, the song indication 404 of the currently played instance of media content 202, the track indication of the currently played instance of media content 202 of the album, and the playback scale 408 with the noted playback location 410 within the currently played instance of media content 202. Also similar to the projected user interface 210-B, the native user interface 502 may also include various playback controls to allow a user to control the playback of the instance of media content 202. For instance, the native user interface 502 may include a rewind control 412, a play/pause control 414, a fast-forward control 416, a repeat control 418, and shuffle control 420 as discussed above.

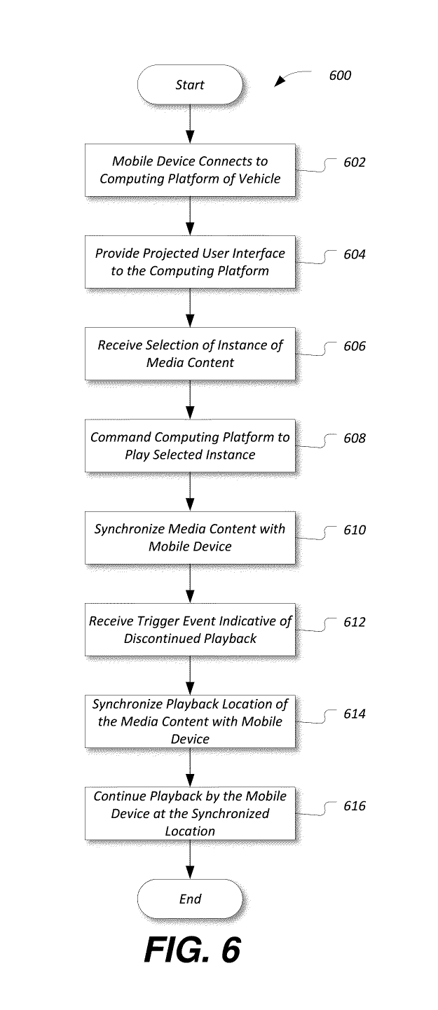

FIG. 6 illustrates an example process 600 for the synchronization of media content 202 between the computing platform 104 and the mobile device 152. The process 600 may be performed, for example, by the media synchronization application 174 executed by the mobile device 152.

At operation 602, the mobile device 152 connects to the computing platform 104 of the vehicle 102. In an example, a driver may plug his or her mobile device 152 into a USB or other wired connection 208 to the computing platform 104 of the vehicle 102. In another example, the mobile device 152 may form a wireless connection 208 between the wireless transceiver 154 of the mobile device 152 and the wireless transceiver 150 of the computing platform 104.

At operation 604, the mobile device 152 provides a projected user interface 210 to the computing platform 104 over the connection 208. In an example, responsive to formation of the connection 208, the computing platform 104 may be configured to request the mobile device 152 to provide the projected user interface 210 for presentation via the HMI of the vehicle 102 (e.g., the display 138, the audio module 122, etc.). The media synchronization application 174 executed by the mobile device 152 may accordingly provide the projected user interface 210-A over the connection 208 to the user via the HMI of the vehicle 102 using a HMI communications protocol.

At operation 606, the mobile device 152 receives a selection of an instance of media content 202 to play back via the computing platform 104. In an example, a user may select a content source 304 from the content sources listing 302 of the projected user interface 210-A, and may further select an instance of media content 202 for the selected content source 304 from the content item listing 306 of the projected user interface 210-A. The mobile device 152 may accordingly receive indications of the HMI input to the vehicle 102 HMI via the connection 208, and may provide the input to the media synchronization application 174 for processing.

At operation 608, the mobile device 152 commands the computing platform 104 to play the requested instance of media content 202. In an example, responsive to the input to the projected user interface 210-A, the media synchronization application 174 may command the computing platform 104 over the connection 208 to cause the media hardware of the vehicle 102 to play the requested instance of media content 202. The command to the computing platform 104 over the connection 208 may make use of as one or more of extensions to the HMI communications protocol.

At operation 610, the mobile device 152 synchronizes media content 202 with the computing platform 104. In an example, the mobile device 152 may command the computing platform 104 over the connection 208 to synchronize the media content 202 to the mobile device 152. In an example, the mobile device 152 may synchronize the instance of media content 202 being played to the mobile device 152. In another example, the mobile device 152 may synchronize the album including the instance of media content 202 being played, or all the instances of media content 202 available for synchronization on the selected content source 304. The synchronization may also make use of one or more of extensions to the HMI communications protocol.

At operation 610, the mobile device 152 receives a trigger event indicative of discontinued playback of the media content 202 by the vehicle 102. As some possibilities, the trigger event may include one or more of a vehicle key-off event, a vehicle park event, a vehicle door open event, and a radio off event, or a selection by the user to discontinue the playback. The trigger event may be provided to the mobile device 152 over one or more extensions to the HMI communications protocol.

At operation 612, the mobile device 152 synchronizes a playback location 410 within the currently played instance of media content 202. In an example, the mobile device 152 may request the current playback location 410 and identifier of the current instance of media content 202 from the computing platform 104 over the connection 208. The synchronization may be performed to the mobile device 152 over one or more extensions to the HMI communications protocol.

At operation 614, the mobile device 152 continues the playback of the instance of media content 202 from the synchronized playback location 410. In an example, the user may press a play/pause control 414 of the native user interface 502 of the mobile device 152 to continue the playback of the instance of media content 202 at the synchronized playback location 410. After operation 614, the process 600 ends.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle system comprising:
a vehicle computing platform configured to
receive, over a connection to a paired mobile device providing a projected mobile device user interface to the vehicle computing platform, media content retrieved from a vehicle hardware source of media content; and
responsive to a trigger event indicative of discontinued playback, synchronize a playback position into the media content being played back by the vehicle to allow the mobile device to continue the playback.

2. The system of claim 1, wherein the trigger event includes at least one of: (i) a vehicle key-off event, (ii) a vehicle park event, (iii) a vehicle door open event, (iv) a radio off event; and (v) receipt of user selection to discontinue playback.

3. The system of claim 2, wherein the vehicle computing platform is further configured to detect the trigger event according to information retrieved from an in-vehicle communication bus configured to carry diagnostic information between vehicle electronic control units.

4. The system of claim 1, wherein the vehicle computing platform is further configured to display a projected user interface of the mobile device via a human-machine interface (HMI) of the vehicle, wherein the projected user interface is received by the vehicle computing platform over the connection.

5. The system of claim 4, wherein the vehicle computing platform is further configured to:
responsive to user input to the projected user interface, send a request to play the media content to the mobile device over the connection; and
receive a command over the connection requesting the vehicle computing platform to play the media content.

6. The system of claim 4, wherein the vehicle computing platform is further configured to:
responsive to user input to the projected user interface, send a request to synchronize the media content from the hardware source of media content to the mobile device over the connection; and
receive a command over the connection requesting the vehicle computing platform to perform the requested synchronization.

7. A system comprising:
a mobile device programmed to
provide, over a connection to a vehicle, a projected user interface of a media application of the mobile device via a human-machine interface of the vehicle; and
responsive to a trigger event indicative of discontinued vehicle playback of an instance of media content, synchronizing to the mobile device, over the connection, a playback position into the media content to allow the mobile device to continue the playback.

8. The system of claim 7, wherein the trigger event includes at least one of: (i) a vehicle key-off event, (ii) a vehicle park event, (iii) a vehicle door open event, (iv) a radio off event; and (v) receipt of user selection to discontinue playback.

9. The system of claim 7, wherein the mobile device is further programmed to synchronize, over the connection, media content retrieved from a hardware source of media content of the vehicle.

10. The system of claim 9, wherein the mobile device is further programmed to receive, over the connection responsive to user input to the projected user interface, a request to synchronize the media content retrieved from the hardware source of media content; and wherein to synchronize the media content is performed responsive to the request to synchronize.

11. The system of claim 7, wherein the mobile device is further programmed to receive, over the connection responsive to user input to the projected user interface, a request to play the media content.

12. The system of claim 7, wherein the connection is a universal serial bus connection.

13. A computer-implemented method comprising:
sending, to a mobile device over a connection between the mobile device and a vehicle paired to the mobile device, media content retrieved from a hardware source of media content of the vehicle; and
responsive to trigger event indicative of discontinued playback, synchronizing a playback position into the media content being played back by the vehicle to allow the mobile device to continue the playback.

14. The method of claim 13, wherein the trigger event includes at least one of: (i) a vehicle key-off event, (ii) a vehicle park event, (iii) a vehicle door open event, (iv) a radio off event; and (v) receipt of user selection to discontinue playback.

15. The method of claim 13, further comprising providing, over the connection, a projected user interface of the mobile device via a human-machine interface (HMI) of the vehicle.

16. The method of claim 15, further comprising receiving, over the connection responsive to user input to the projected user interface, a request to play the media content.

17. The method of claim 15, further comprising receiving, over the connection responsive to user input to the projected user interface, a request to synchronize the media content retrieved from the hardware source of media content; and wherein to synchronize the media content is performed responsive to the request to synchronize.
